(19) United States
(12) Patent Application Publication
(10) Pub. No.: US 2003/0152850 A1
(43) Pub. Date: Aug. 14, 2003

(54) Rule-based methods for proximity-effect correction of charged-particle-beam lithography pattern using subregion-approximation for determining pattern element bias

(75) Inventor: Koichi Kamijo, Kumagaya-shi (JP)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 10/359,800

(22) Filed: Feb. 6, 2003

(30) Foreign Application Priority Data
Feb. 12, 2002 (JP) 2002-033338

(51) Int. Cl. G03C 5/00

(52) U.S. Cl. 430/30; 430/296; 430/942

(57) ABSTRACT

Methods are provided for determining bias of pattern elements of a pattern to be defined on a reticle for use in charged-particle-beam microlithography. The pattern elements, as defined on the reticle, are biased as required to reconfigure the pattern elements sufficiently to offset the proximity effect when the reconfigured pattern elements are projected onto and imprinted in a layer of resist on a lithographic substrate. The subject methods involve subregion-approximation to reduce calculation time while producing bias data that achieves pattern-transfer results that are sufficiently similar to as-designed ideal results of pattern-transfer accuracy and fidelity. For example, within a first subregion of the pattern the backscatter is different at each pattern-element location than in a second subregion. Within the first subregion on the reticle, all pattern element(s) are biased identically, and within the second subregion, all pattern element(s) are biased identically, but not necessarily at the same bias magnitude as in the first subregion position. Calculation of respective biases is made at the subregion level rather than the conventional element-by-element level, thereby reducing calculation complexity and hence calculation time.

### FIELD

This disclosure pertains to projection microlithography (pattern transfer from a pattern-defining reticle to a lithographic substrate) performed using a charged particle beam such as an electron or ion beam. Microlithography is a key technique used in the fabrication of microelectronic devices such as semiconductor integrated circuits, displays, micromachines, and the like. More specifically, the disclosure pertains to methods for configuring individual pattern elements on the reticle in a manner that compensates for proximity effects that otherwise would occur as the reticle pattern is imprinted on the substrate, and to computer-readable media containing programs corresponding to the methods.

### BACKGROUND

As noted above, fabrication processes for microelectronic devices such as semiconductor integrated-circuit devices typically include multiple microlithography steps. During a microlithography step a pattern, defined on a reticle (also termed a “mask”), is transferred using an energy beam to a sensitized lithographic substrate such as a semiconductor wafer. In recent years, the relentless demands for progressively higher levels of integration (leading to progressively greater miniaturization) of active circuit elements in microelectronic devices have revealed the limitations of performing microlithography using ultraviolet light (termed “optical” microlithography). In other words, the ultra-fine pattern resolution now being demanded exceeds the diffraction-limited capability of optical microlithography tools. Consequently, substantial effort currently is being expended to develop a practical “next generation lithography” (NGL) technology.

The currently most promising NGL approaches involve use of either a charged particle beam (e.g., electron beam or ion beam) or an X-ray beam as the lithographic energy beam. In this regard, electron-beam projection-microlithography tools are nearing practical realization. These tools advantageously provide good beam control using electrical lenses and deflectors, and have been shown to produce finer pattern resolution than obtainable using optical microlithography.

A charged particle beam is not and does not behave as a beam of electromagnetic radiation. This is because a charged particle beam is a beam of moving particles. Interaction of the charged particle beam with a layer of resist on the surface of the lithographic substrate (and with the substrate itself) exhibits a phenomenon termed the “proximity effect.” Proximity effects are manifest as anomalous changes in exposure dose at the edges and corners of projected pattern elements caused by charged particles interacting with the resist in regions adjacent to locations at which exposure is desired, including neighboring pattern elements. As a charged particle enters a layer of resist, the particle experiences forward- and backscattering behavior. Forward-scattering occurs in the resist as the charged particle travels depthwise into the resist while experiencing relatively low-angle deviations from its incident trajectory caused by collisions with atoms in the resist. Backscattering results from elastic collisions of the charged particle with atoms of the substrate, and typically involves much higher-angle deviations of the charged particle from its incident trajectory. Both types of scattering events result in the scattered charged particles contributing exposure energy to proximal neighboring regions of the resist, including regions in which exposure is not desired. Thus, the scattered charged particles can cause partial to complete exposure of the resist in the neighboring regions. This unwanted exposure of proximal regions of resist can seriously degrade the ability of individual pattern elements to be imprinted with high fidelity to their as-designed configurations, as well as the ability of neighboring pattern element(s) to be resolved from one another. Forward-scattering also reduces the exposure energy that should be concentrated in regions of the resist at which exposure is desired.

The energy intensity distribution (EID) accumulated in a plane in the resist from a charged particle beam irradiating a point (x, y) on the surface of the resist can be described by a double-Gaussian model expressed as a sum of two Gaussian distributions:

$$\begin{matrix}E ( x , y ) = ( \frac{1}{1 + η} ) ( \frac{1}{π {σ}_{f}^{2}} ) exp [ \frac{- ( {x}^{2} + {y}^{2} )}{{σ}_{f}^{2}} ] + \\ ( \frac{η}{1 + η} ) ( \frac{1}{π {σ}_{b}^{2}} ) exp [ \frac{- ( {x}^{2} + {y}^{2} )}{{σ}_{b}^{2}} ]\end{matrix} \qquad ( 1 )$$

In Equation (1), the first term on the right represents forward-scatter energy, and the second term represents backscatter energy. The variables σ_{f} and σ_{b} are forward-scattering radius and backscattering radius, respectively, and each represents a correspondingly increased “width” of the subject exposed region of the resist caused by the respective scattering event. (This increased “width” is manifest in part as an apparent “blur” of the images of pattern elements as projected onto the resist.) The variable η is the backscattering coefficient, which is a ratio of backscatter energy to forward-scatter energy. The contribution of the EID to blur of a charged particle beam usually is expressed by a root mean square of the Gaussian width of focus and the forward-scattering radius, which allows a new forward-scattering radius to be calculated.

Conventional methods for offsetting changes in as-exposed pattern-element profiles and dimensions caused by the proximity effect include dose modulation, in which the exposure dose (intensity of irradiation) is changed as a function of the shapes and density of individual pattern elements being lithographically exposed. Thus, each element is exposed with a respective dose that prints the element at the proper size and shape on the resist. Another conventional method involves changing the shapes of individual pattern elements as defined on the reticle (making such changes is termed “reconfiguration” or “local resizing” of the elements), so as to achieve desired corresponding pattern-element shapes as projected onto the resist. Conventional methods of pattern-element reconfiguration can be divided broadly into two types of methods: model-based methods and rule-based methods.

Model-based methods employ mathematical models of the exposure process to determine the corrections to be obtained by reconfiguring pattern elements. The obtained corrections are based on a convolution of pre-defined EID functions and the actual reticle pattern. The edges of pattern elements to be defined on the reticle are divided into segments according to a pre-defined grid. The segments are shifted (according to predefined respective EID functions) to create reconfigured pattern elements. The reconfigured pattern elements can be used after one cycle of calculation or iteratively subjected to one or more subsequent calculation cycles (so as to converge more accurately on the optimally reconfigured pattern elements for producing the desired exposure-energy profiles in the resist on the substrate).

General aspects of a model-based method are shown in FIGS. 7(a)-7(d). FIG. 7(a) depicts an exemplary pattern element having a shape that would be defined on the reticle if exposure thereof could be made without any proximity effect. The pattern-element shape shown in FIG. 7(a) also represents the desired (“ideal”) shape of the pattern element as projected onto the resist. Reconfiguration of this pattern element, according to the model-based method, begins with dividing the edges (outline) of the pattern element, as shown in FIG. 7(a), into segments according to a pre-defined grid. The superposed curve (shown for example as an ellipse for simplicity) in FIG. 7(b) denotes the actual shape of the FIG. 7(a) pattern element, resulting from the proximity effect, as projected onto the resist (this as-projected shape in FIG. 7(b) was determined using a simulation). The region inside the curve represents the area of the resist that received an exposure dose in excess of the imprinting dose threshold for the resist.

To achieve better exposure fidelity of the pattern element, the segments are shifted inwardly or outwardly, according to their respective EID functions, as generally indicated (respective arrows) in FIG. 7(b). In general, segments located inside the curve are shifted inward and segments located outside the curve are shifted outward relative to the curve. If a segment crosses the curve, the shifting direction can be determined, for example, by: (a) calculating the area of the region enclosed by the curve and the segment, and (b) if the area of the “inner” region is larger than of the “outer” region, then the segment is shifted inwardly; if not, then the segment is shifted outwardly. The result of this segment-shifting is shown in FIG. 7(c). The corresponding reconfigured pattern element is produced by connecting together the displaced segments, as shown in FIG. 7(d). A computer simulation of exposure of the reconfigured pattern element (FIG. 7(d)) is performed to determine the shape of the corresponding as-exposed pattern element in the resist. If the as-exposed shape deviates excessively from the ideal, then the sequence of steps shown in FIGS. 7(a)-7(d) is repeated one or more times. This iterative process eventually converges on a shape of the pattern element, as defined on the reticle, that will yield, as closely as possible, the ideal as-exposed shape.

Rule-based methods are performed according to a set of rules set forth in a standard table of pre-calculated “bias” data. A “bias” is a positional shift, based on the table, made to an edge of a pattern element as defined on the reticle so as to increase or decrease the exposure dose at the pattern element as imprinted in the resist. The bias data are calculated from, for example, corresponding backscatter amounts expected to be experienced by the respective pattern elements as exposed onto the resist. The calculations are based on the sizes, shapes, and environment (e.g., densely packed or sparsely distributed) of the pattern elements (and neighboring pattern elements) as defined on the reticle. For each pattern element, corresponding bias data are looked up in the table, and the edges of the pattern element as defined on the reticle are biased accordingly.

In the model-based method, the number of individual calculations increases with the square of the number of segments. Consequently, model-based calculations are massive and normally require a large amount of computer time to perform.

In the rule-based method massively complicated calculations are not necessary (using a computer to look up data in a table does not require very much computer-processing time), so the required processing time is substantially shorter than in a model-based method. (However, a significant amount of computing time is required to create the table.) Unfortunately, the rule-based method yields reconfigured (biased) pattern elements that, when exposed onto the resist, typically correspond less accurately to the ideal than pattern elements reconfigured by a model-based method. For example, in a region of the pattern characterized by a dense arrangement of pattern elements, the backscatter amount (after pattern-element reconfiguration compared to before reconfiguration) changes only to the extent that neighboring pattern elements have been biased. Consequently, the as-exposed pattern elements produced by a reticle with pattern elements that have been biased according to a rule-based method can have shapes and/or sizes that are significantly different from the ideal. This is shown in FIGS. 8(a)-8(b), which depict only one dimension for simplicity. FIG. 8(a) shows the results of exposing a dense array of line-and-space (L/S) pattern elements that have not yet been biased to compensate for the proximity effect. As can be seen, the exposure-energy profile is offset (vertically in the figure) by additional exposure energy contributed by backscatter. When these pattern elements are projected onto the resist, exposure occurs wherever exposure energy exceeds the threshold. Consequently, the as-projected pattern elements have respective line-widths that are wider than desired. After applying conventional rule-based biasing to reduce the contribution of backscatter to the overall exposure-energy profile, the line-widths are narrowed (i.e., the width of intervening spaces is increased), as shown in FIG. 8(b). (Note the downward shift in the energy profile relative to the threshold.) However, because this biasing reduces the widths of the pattern elements as defined on the reticle, the overall proportion of exposure energy exceeding the threshold is reduced, which causes the as-exposed line-widths to be narrower than desired.

### SUMMARY

The present invention considered the sort of problems described above, so it addresses the issue of providing a reticle pattern determination method that can calculate swiftly while maintaining the required precision, and of providing a computer program for the reticle pattern determination method.

A first aspect of the invention is directed, in the context of a pattern to be microlithographically transferred from a reticle to a substrate using a charged particle beam, to methods for determining respective configurations of elements of the pattern as defined on the reticle so as to reduce proximity effects on the pattern elements as the pattern elements are transferred to the substrate. An embodiment of such a method comprises a first step of dividing the pattern, as defined on the reticle, into multiple subregions each containing one or more respective pattern elements. In a subsequent step, for each subregion, a respective bias is determined that is to be applied to the one or more respective pattern elements in the subregion to reduce a proximity effect that otherwise would be manifest when the subregion is transferred to the substrate. In a subsequent step the determined respective bias is applied to the respective one or more pattern elements in each subregion, so as to reconfigure the respective pattern elements, as defined on the reticle, in each subregion in which bias is applied.

The method further can comprise the step, for each subregion, of determining a backscatter-energy contribution that would have a significant effect on the total backscatter energy in the subregion, if the bias were not applied, when the subregion is projected onto the substrate. The step of determining the bias can comprise calculating the bias for a respective subregion by taking into account the backscatter, occurring inside and outside the respective subregion, that would have the significant effect on total backscatter energy in the respective subregion. The step of taking into account the backscatter occurring inside and outside the respective subregion can comprise calculating a change in backscatter energy in the respective subregion achieved by biasing pattern elements inside and outside the respective subregion. The step of calculating the change in backscatter energy can comprise calculating respective changes in backscatter energy corresponding to changes in bias applied to pattern elements inside and outside the respective subregion.

The step of calculating backscatter energy corresponding to changes in bias can comprise calculating respective changes in area of the pattern elements inside and outside the respective subregion. For each such pattern element, the change in area can be calculated from a total perimeter length, a total number of projecting vertices, and a total number of indented vertices of the pattern element.

The step of determining the backscatter-energy contribution can comprise determining a change in backscatter energy caused by a change in bias of pattern elements inside and outside the respective subregion. This embodiment of the method further can comprise the step of calculating the change in bias of the pattern elements. The change in bias of the pattern elements can be calculated, for each respective pattern element, by calculating a respective change in area of the respective pattern elements. The change in area can be calculated from a total perimeter length, a total number of projecting vertices, and a total number of indented vertices of the respective pattern element.

The step of determining the bias further can comprise taking into account a respective blur of the charged particle beam used to transfer the respective subregion from the reticle to the substrate. This embodiment of the method further can comprise the step of calculating the respective blur.

The step of determining the respective backscatter-energy contribution in a subject subregion can comprise performing an iterative calculation of a change in backscatter energy significantly affecting the subject subregion caused by respective changes in pattern-element area, resulting from application of respective biases, in a group of subregions including the subject subregion and subregions neighboring the subject subregion. Each of the neighboring subregions included in the calculation desirably exhibits a backscatter that significantly affects the backscatter energy in the subject subregion. The step of performing the iterative calculation can comprise the following steps: (a) calculating a backscatter-energy contribution, to the subject subregion, from subregions located within a predetermined distance from the subject subregion and that exhibit respective backscatter amounts having a significant effect on the total backscatter energy in the subject subregion; (b) calculating, from the backscatter-energy contributions calculated in step (a) and from beam blur, a corresponding bias at each of the subregions; (c) calculating, from the biases calculated in step (b), corresponding changes in pattern-element area in each of the subregions; (d) calculating, from the changes in pattern-element area determined in step (c), corresponding changes in backscatter energy in each of the subregions; and (e) repeating steps (b)-(d) at least once. The step of determining the respective backscatter-energy contribution in the subject subregion further can comprise determining, of the neighboring subregions, a set of subregions exhibiting respective backscatter amounts that have a significant effect on total backscatter energy in the subject subregion. Within the set of neighboring subregions, a distance range is determined from the subject subregion that divides the neighboring subregions into a first group of subregions that are relatively close to the subject subregion and a second group of subregions that are relatively distant from the subject subregion. In this instance the step of determining the total backscatter energy in the subject subregion includes taking into account respective contributions of change in backscatter energy from neighboring subregions within the distance range and ignoring respective contributions of change in backscatter energy from neighboring subregions at or beyond the distance range.

The step of determining the respective backscatter energy in a subject subregion can comprise establishing a set of simultaneous equations for the subject subregion. The equations in the set pertain to respective contributions by neighboring subregions of respective backscatter energies having a significant effect on the proximity effect in the subject region and in which equations an unknown is the respective bias in the respective subregion. The set of simultaneous equations is solved to determine the bias to be applied in the subject subregion. The step of determining the respective backscatter energy in the subject subregion can comprise performing an iterative calculation of a change in backscatter energy affecting the subject subregion caused by respective changes in pattern-element area, resulting from application of respective biases in the neighboring subregions. Each of the neighboring subregions included in the iterative calculation desirably exhibits a respective backscatter amount that significantly affects the total backscatter energy in the subject subregion.

According to another aspect of the invention, computer-readable media are provided that are inscribed with a computer program encoding any of the method embodiment methods, and alternatives thereof, summarized above. A computer-readable medium can be, for example, a memory card, a compact digital disc, a magnetic disc, or other suitable medium.

The foregoing and additional features and advantages of the invention will be more readily apparent from the following detailed description, which proceeds with reference to the accompanying drawings.

### BRIEF DESCRIPTION OF THE DRAWINGS

FIG. 1 shows respective portions of two subregions containing respective pattern elements subjected to respective biases according to a representative embodiment. Also shown are a plot of cumulative exposure energy, the resist threshold, and backscatter energy.

FIG. 2 is a plot of the shift ΔU in the exposure-energy profile due to backscatter in a particular subregion, the corresponding shift in an edge of a pattern element, and a corresponding bias Δx made according to the representative embodiment.

FIG. 3 is a plan view of an exemplary pattern element of which the edges have been moved outward by application of a bias Δx, causing a corresponding increase ΔS in pattern-element area. Also shown are “projecting vertices” and “indented vertices” of the pattern element shows changes in pattern area due to adding a bias amount.

FIG. 4 is a plan view of regions A and B of respective subregions surrounding a subregion P in which proximity-effect correction is to be calculated according to the representative embodiment.

FIG. 5(a) is a plan view of a one-dimensional array of linear pattern elements and intervening spaces (pattern-type (1)) used in a first example.

FIG. 5(b) is a pattern (pattern-type (2)) used in a second example.

FIG. 6 is a flow-chart of calculation steps in an iterative calculation of bias and backscatter energy according to a representative embodiment.

FIGS. 7(a)-7(d) are plan views showing respective steps involving pattern-element reconfiguration performed using a conventional model-based method of proximity-effect correction.

FIGS. 8(a)-8(b) depict certain aspects of results obtained with a conventional rule-based method of proximity-effect correction.

### DETAILED DESCRIPTION

The invention is described below in the context of representative embodiments that are not intended to be limiting in any way.

Methods according to the invention are directed, inter alia, to determining the configurations of elements of a pattern to be defined on a reticle as used for performing charged-particle-beam microlithography. The elements are reconfigured (from their as-designed configurations) so as to offset proximity effects, and the calculations required to determine the configurations require substantially less computing time than conventional methods, while still providing an as-projected fidelity of pattern elements that is within acceptable tolerances.

General Considerations

Generally, the subject methods involve a “subregion-approximation” method of determining bias to be applied to pattern elements. In general, the pattern is divided into multiple subregions. In each subregion, a respective proximity-effect correction is performed by deliberately reconfiguring the respective pattern element(s) (or portion(s) thereof) in the subregion. In each subregion, the constituent element(s) (or portion(s) thereof) are reconfigured by applying the same magnitude of bias to pattern-element edges throughout the subregion. As noted above, a “bias” is a shift imparted to an edge of the pattern element. A bias has both magnitude and direction. Hence, in a particular subregion, if the edge of a pattern element is shifted “outward” a distance Δx, resulting in a widening of the pattern element, then all pattern-element edges (that can be so shifted) in the subregion are shifted “outward” by Δx. A similar principle applies with respect to shifts (if made) having magnitude Δy. In a particular subregion, Δx and Δy need not be (and typically are not) equal to each other. Also, either or both Δx and Δy can be zero in a particular subregion.

Reference now is made to FIG. 1, which depicts a one-dimensional example involving two subregions 1, 2. Also shown is the boundary (vertical dashed line) between the subregions 1, 2. The thick black lines indicate respective elements of the reticle pattern, viewed in elevational section. In subregion 1, the amount of backscatter is different at each pattern element (i.e., in the figure, backscatter energy increases with each pattern element successively to the right in subregion 1). According to a conventional method, the bias applied to each successive pattern element to the right in subregion 1 would be different, commensurately with the different backscatter energy received by the respective pattern element as exposed onto the resist. According to the instant embodiment, in contrast, the bias Δx₁ applied to the pattern elements in subregion 1 is constant in magnitude (direction is changed depending upon whether the subject edge is a right-hand edge or left-hand edge; note directions of bias Δx₁ shown in the figure). In the adjacent subregion 2 a different (albeit constant in magnitude throughout the subregion) bias Δx₂ is applied to each of the pattern elements in that subregion.

Respective bias determinations similarly are made for all the other subregions of the pattern. But, in contrast to the conventional method, the volume of calculations required in the instant embodiment is substantially reduced because bias calculations are performed on the subregion level rather than on the individual pattern-element level, which correspondingly reduces the calculation time.

The particular sizes of the subregions desirably are appropriate for the particular pattern defined on the reticle, the particular resist, the particular exposure conditions, and the tolerable discrepancy of as-exposed pattern elements relative to ideal that is achieved. For example, the proximity effect obtained from biasing according to a conventional element-by-element method versus the proximity effect obtained from biasing using the instant subregion-approximation method can be compared. If the instant subregion-approximation method yields insufficient correction of the proximity effect, then the subregion size can be reduced and the biases recalculated based on the reduced subregion size. If the difference in result obtained by the subregion-approximation method versus the result obtained by the strict element-by-element method represents an acceptable process tolerance, then the subregions need not be reduced further in size and the results obtained in the subregion-approximation method used for reconfiguring the pattern elements on the reticle. Thus, the required calculations for pattern-element reconfiguration need not be any more complicated (or time-consuming) than necessary to achieve an acceptable level of proximity-effect correction. In other words, by not making the subregion size any smaller than necessary, harmonization is attained between calculation precision and calculation speed. In addition, the amount of backscatter that can be tolerated in actual practice can be determined from the obtained error in as-projected pattern elements.

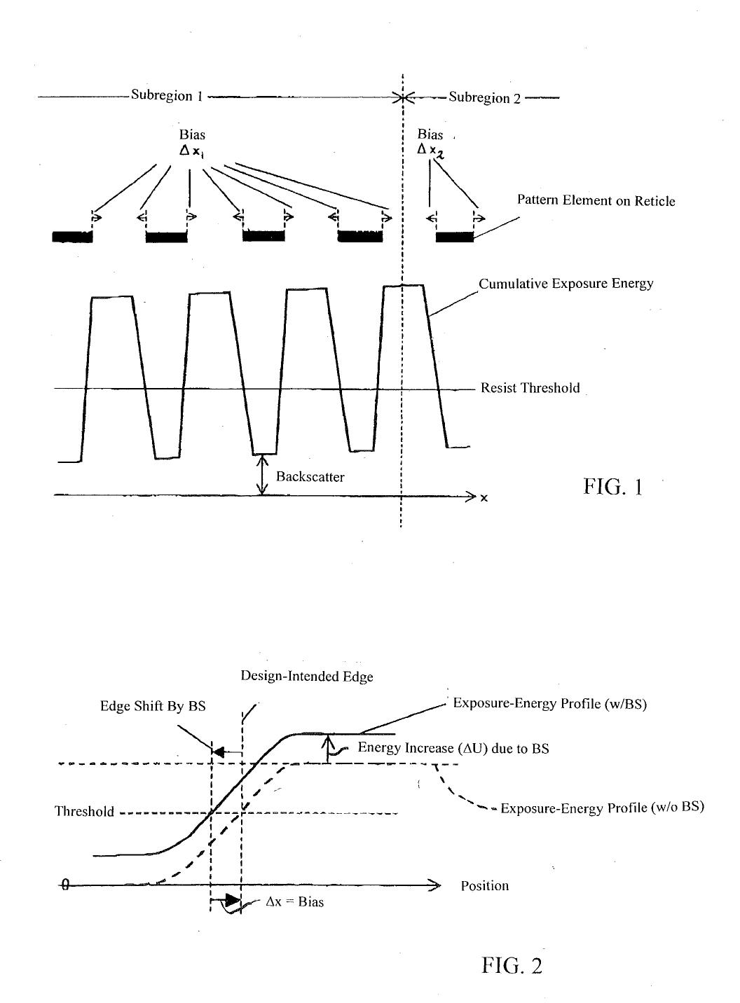

The magnitude of bias applied to pattern element(s) within a given subregion P can be calculated based not only on the total backscatter energy in the subregion P but also on the magnitude of blur exhibited by the charged particle beam used for exposing the subregion P. The basic principle of this is shown in FIG. 2. The broken-line curve is the exposure-energy profile at a pattern-element edge in the absence of backscatter (BS). This curve is a plot of exposure-energy data obtained from a convolution of the first term in Equation (1) and a step function in which x≧0=1 and x<1=0. The forward-scattering radius σ_{f} appearing in Equation (1) takes into account the blur of the charged particle beam as described above. Similarly, the solid-line curve is of exposure-energy data resulting from a convolution of Equation (1) and the step function in the presence of backscatter.

Note in FIG. 2 that the energy profile “rises” by ΔU by accounting for backscatter in the particular subregion. The energy shift ΔU causes a point on the curve corresponding to the exposure-energy threshold to shift to the left in the figure. The magnitude of bias Δx that should be applied to the pattern element(s) in the subregion may be sufficiently large to offset this shift. The magnitude of this bias Δx can be calculated as:

Δx=−ΔU/α (2)

wherein ΔU is the backscatter energy received in the subregion, as shown in FIG. 2, and α is the slope of the energy-profile curve (corresponding to blur of the charged particle beam exposing the subregion P; see below) at an edge of a pattern element in the subregion. A positive bias denotes a shift direction yielding an increased width of the respective pattern element, and a negative bias denotes a shift direction yielding a decreased width of the respective pattern element.

In the foregoing, no (i.e., zero) displacement of the energy profile occurs under zero-backscatter conditions in the subregion. Zero backscatter is denoted ΔU₀. Taking ΔU₀ into account, Equation (2) is rewritten:

Δx=−(ΔU−ΔU₀)/α (3)

Blur of the charged particle beam at the resist is denoted by “β”. Blur corresponds to a range between approximately 12% and approximately 88% of the full height of the energy profile. The slope a can be expressed using Equation (4):

$$α = \frac{( 0.88 - 0.12 )}{( 1 + η ) β} \qquad ( 4 )$$

in which η is the backscatter coefficient.

When calculating backscatter energy at a subregion P, iterative calculations can be performed to determine more accurately the change in respective areas of the as-projected pattern elements of the subregion P caused by biasing the respective pattern element(s) both within the subregion P and in subregions that neighbor the subregion P (and that significantly affect the backscatter energy in the subregion P). These “neighboring” subregions can include subregions adjacent the subregion P as well as subregions located more distantly from the subregion P than adjacent subregions. As noted, not all neighboring subregions necessarily contribute significant backscatter energy to the subregion P. For example, if a neighboring subregion has a sparse distribution of pattern elements or has pattern element(s) that occupy a very small area of the subregion, then its backscatter-energy contribution to the subregion P may be insignificant. In the subregion P and in these neighboring subregions, as the pattern element(s) are biased, the respective areas of the pattern element(s) change, which causes respective changes in backscatter energy in the subregion P from the initial backscatter energy used in the first calculation. Thus, the iterative calculations, in which backscatter energy is recalculated after changing the shapes of pattern element(s), takes into account the change in backscatter energy caused by biasing pattern elements in the subregion P and in those subregions that neighbor the subregion P (and that significantly affect backscatter in the subregion P). The iterative calculation also takes into account changes in backscatter energy caused by biasing the pattern element(s) located within the same subregion P.

The iterative calculation allows determinations of pattern-element shapes to be defined on the reticle, with a desired degree of precision. The iteration effectively is as follows: (calculate initial backscatter energy)→(determine initial bias)→(recalculate area of pattern element(s) due to bias)→(recalculate backscatter energy)→(redetermine bias)→ . . . . As noted, the iteration is repeated as required to obtain a desired convergence of the results in view of limitations in calculation time. Iteration typically is halted when a freshly determined bias varies from the previously determined bias by a difference that is no greater than an allowable process tolerance or other limit imposed by the practitioner. It also is possible, for convenience, automatically to perform multiple iterations and to stop calculating after a predetermined number of iterations (e.g., 2 or 3 iterations). In these iterative calculations, those subregions that neighbor the subregion P (and that significantly affect backscatter in the subregion P) may be selected as those particular subregions from which the respective contributions of exposure energy to the subregion P are individually equal to or greater than a particular influence threshold.

Calculating backscatter energy in the subregion P can be performed using simultaneous equations in which the unknown is the magnitude of bias in the respective subregion. As noted above, changes in backscatter energy in the subregion P are caused by respective changes made in the areas of pattern element(s) in the subregion P as well as such changes made in neighboring subregions (that significantly affect backscatter energy in the subregion P). These respective backscatter-energy contributions are described by respective equations, and the respective equations collectively constitute the simultaneous equations. The respective magnitude of bias in each subregion is found by solving the respective set of simultaneous equations. This is discussed later below.

In the iterative calculation, when recalculating backscatter energy in the subregion P, the subregions that neighbor the subregion P (and that significantly affect backscatter energy in the subregion P) can be divided into a subregion-group A (separated by a relatively short distance from the subregion P) and a subregion-group B (separated by a relatively long distance from the subregion P). The recalculation can take into account the change in backscatter energy in the subregion P due to respective changes in pattern-element area in the subregions of group A, while ignoring any change in backscatter energy in the subregion P due to respective changes in pattern-element area in the subregions of group B. This simplification is effective because, whenever a pattern is divided into subregions, backscatter in a subregion that is relatively far from a specific subregion P normally exerts a very small effect on the resist-exposure events occurring in the subregion P. Also, compared to the contribution by an entire distant pattern element to backscatter energy in the subregion P, the change in area of the distant pattern element imparted by biasing its edges contributes much less backscatter energy affecting the subregion P. Therefore it often is possible to ignore changes in cumulative energy dose in the subregion P due to changes in pattern-element areas made in distant subregions. By ignoring the effects of these distant changes, the volume of calculation, and hence the calculation time, are substantially reduced, especially in iterative calculations.

Of course, as an alternative and as desired, the backscatter energy contributed by both relatively near subregions (group A) and relatively distant subregions (group B) can be included in calculations involving backscatter-energy contributions from subregions neighboring the subregion P (and that significantly affect backscatter energy in the subregion P). The subregions of both groups A, B also can be considered when calculating the effect of backscatter before any pattern elements are biased.

The change in area of pattern elements reconfigured by biasing can be found from the lengths of respective perimeters of the pattern elements within the subject subregion and from other data such as the number “T” of “projecting vertices” of the elements, the number “Q” of “indented vertices” of the elements, the perimeter length “p” of each element, and the magnitude of bias Δx applied to the subregion. By determining p, T, and Q beforehand, the area increase or decrease ΔS imparted by biasing Δx the pattern elements can be found using the expression:

ΔS=pΔx+(T−Q)Δx² (5)

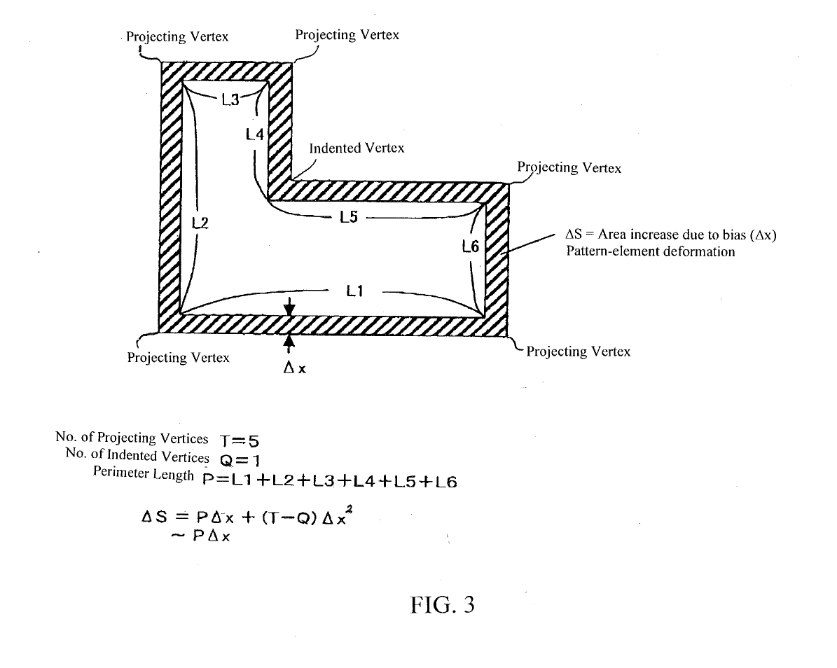

An example is shown in FIG. 3, in which the depicted pattern element has T=5 projecting vertices, Q=1 indented vertex, and has been enlarged by biasing Δx (hatched area). If Δx is sufficiently small, then the Δx² term can be omitted from Equation (5), in which case ΔS=pΔx.

### EXAMPLE EMBODIMENT

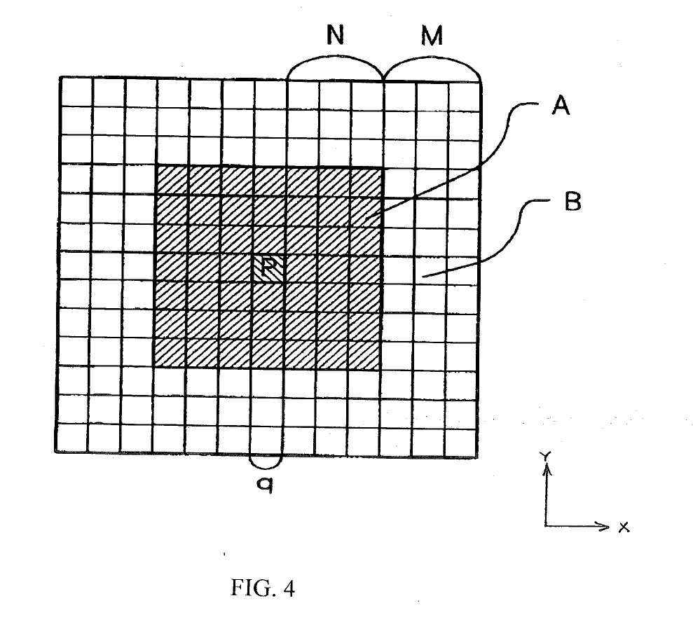

Reference now is made to FIG. 4, which depicts a region of a pattern in which proximity-effect correction is to be made according to this example embodiment. In the figure, “q” denotes the length of a side of a square subregion P containing constituent pattern element(s) of which the respective bias is to be calculated (all bias in the subregion P will be the same). The subregion P is surrounded by a region A having a width, extending outward in the X and Y directions from the subregion P, of “N” subregions (three subregions wide in the figure). Similarly, the region A is surrounded by a region B having a width, extending outward in the X and Y directions from the region A, of “M” subregions (three subregions wide in the figure). Each of the regions A, B contains multiple subregions each sized and shaped similarly to the subregion P. In this example both regions A and B are within a distance range, relative to the subregion P, in which backscatter occurring in any of the constituent subregions of the regions A, B can affect exposure of the pattern elements in the subregion P to a significant degree. Hence, a calculation of bias to be applied in the subregion P involves taking into account the respective backscatter occurring in the respective subregions (that in fact do affect backscatter energy sufficiently in the subregion P) of the regions A and B.

The width of a distance range R, outward from the subject subregion P, in which backscatter-energy contributions to the subregion P are taken into account is determined by considering whether errors in size, shape, and resolution of pattern elements in the subregion P due to proximity effects caused by these backscatter-energy contributions are within an acceptable tolerance from ideal (i.e., are within applicable specifications) whenever contributions from locations outside the range are ignored. That is, a calculation is made of the cumulative dose of exposure energy in the subregion P contributed by backscatter in subregions located less than the range R from the subregion P. Calculations also are made of the exposure-energy contribution to the subregion P by backscatter occurring in a subregion located at a distance “r” from the subregion P, wherein R≦r≦∞. As a control, similar calculations are made of the exposure-energy contribution to the subregion P by backscatter occurring in subregions located less than the range R from the subregion P, but with contributions by subregions located in the range “r” being ignored. The difference between the results of these two calculations is a cumulative dose “error” introduced by ignoring the contributions from subregions located within the range “r”. Continuing, the approximate magnitude of bias change, to the pattern element(s) in the subregion P, represented by this cumulative-dose error is calculated. The distance range R is established as the distance beyond which the bias change is sufficiently small that the change can be ignored while still providing as-projected pattern element(s) from the subregion P having shapes and sizes that are within applicable specifications.

For a particular pattern, a practical size of individual subregions can be determined by establishing a “proposed” subregion size and evaluating the error effect, on pattern element(s) projected from the proposed subregion, contributed by backscatter occurring outside the proposed subregion. The result of this calculation is compared with results obtained using the conventional element-by-element method of calculating bias. This calculation and comparison (subregion-approximation iteration) is continued for different subregion sizes until a maximum subregion size is determined that still produces an error that is within applicable specifications. As noted above, the larger the permissible subregion size, the less time required for performing the bias calculations for the pattern. Hence, a harmonization is reached between the accuracy and precision of bias-calculation sufficient for achieving a desired fidelity of pattern-element projection and calculation time by making the subregion size as large as possible. The error in backscatter energy in any subregion P that can be allowed from a practical standpoint can be determined from the realized error in as-exposed pattern elements that can be allowed from a practical standpoint.

Returning to FIG. 4, the maximal distance from the subregion P in which backscatter-energy contributions to the subregion P are taken into account is not necessarily the outer perimeter of the region B. Alternatively, backscatter-energy contributions to the subregion P can be considered from any subregion in the region A but not from any subregion in the region B.

### EXAMPLES AND COMPARISON EXAMPLE

The normal backscattering radius of a 100-KeV electron beam incident on Si is approximately 30 μm. Under such conditions a reticle pattern was divided into subregions in which the respective pattern element(s) were to be biased to correct for proximity effects. A region A was centered on the subregion P so as to surround the subregion P. The region A had a width, outward from the subregion P, of 30 μm on each side (60 μm total width). Similarly, a region B, surrounding the region A, had a width, outward from the region A, of 30 μm on each side (60 μm total width). Two examples were considered: In the first example q=10 μm, N=3 subregions (yielding a width of 30 μm on each side), and M=3 subregions (yielding a width of 30 μm on each side). In the second example q=5 μm, N=6 subregions (yielding a width of 30 μm on each side), and M=6 subregions (yielding a width of 30 μm on each side). Two levels of beam blur were considered in each example: 50 nm and 70 nm.

In each example and in the comparison example, Pattern-element-exposure thresholds “θ” were evaluated for two cases, denoted (a) and (b). Using a notation in which the maximum cumulative-exposure energy in the resist has a normalized standard value of “1”, the two cases were:

θ=[1/(1+η)]/2=0.3571 (a)

θ={[(1/(1+η))/2]+(½)}/2=0.4286 (b)

In case (a) the exposure threshold θ required no (zero-percent) reconfiguration of linear pattern elements wherever backscatter caused essentially no proximity effect. In case (b) the exposure threshold θ was an average of the exposure threshold in case (a) and an exposure threshold that required no reconfiguration of linear pattern elements wherever backscatter energy was regarded as essentially 50% of the maximum backscatter energy. (The maximum backscatter energy is η/(1+η) per the normalization noted above. The magnitude of bias was not expected to be very large in either case (a) or case (b).

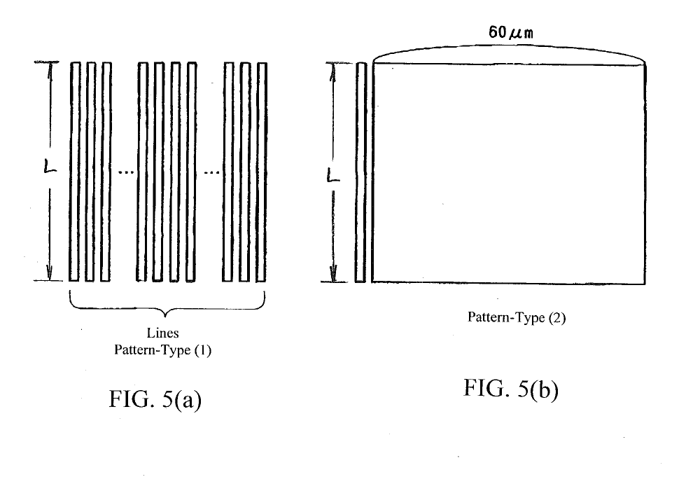

The following two types of patterns were used as exemplary patterns for proximity-effect correction in each example and in the comparison example. In both types of patterns the cumulative dose of exposure energy, due to backscatter, calculated using pre-biased pattern elements was essentially the same at a “point of investigation” located at the center of the subregion P. In pattern-type (1) (see FIG. 5(a)) the point of investigation was in a center (median) element of a linear array of 601 linear elements each having a line-width of 100 nm (1:1 line/space ratio). In pattern-type (2) (see FIG. 5(b)) the point of investigation was in a 100-nm wide linear element situated adjacent a 60-μm wide large pattern element, with a 100-nm gap between the two elements. In both types of patterns the length L of each pattern element in its longitudinal direction (vertical in FIGS. 5(a)-5(b)) was equal to or greater than the length of one side of the region B (including region A) in FIG. 4. This length L is greater than the backscattering radius. In making proximity-effect corrections in each example, calculations of necessary corrections were made at a point of investigation located at the center of the subject linear pattern errors. By doing so, one can use the approximation in which the results of proximity-effect corrections correspond to a calculation based approximately on a one-dimensional model. In the lateral direction of FIGS. 5(a)-5(b), the lattice of subregions shown in FIG. 4 were successively applied and calculated so that the subject subregion for which the calculations were performed was the subregion P.

In the comparison example, a one-dimensional model-based calculation was performed. The resulting line-widths (nm) obtained after reconfiguration of the elements of pattern types (1) and (2) noted above (FIGS. 5(a) and 5(b)) are shown in Table 1, below. In this case, the calculation time required for reconfiguring a pattern sized to fit on a 10 mm×10 mm chip was 35.56 hours for pattern-type (1) (FIG. 5(a)) and 1.78 hours for the pattern-type (2) (FIG. 5(b)), using a SPARC® computer (450 MHz, 1 CPU).

TABLE 1
Comparison Example

| Blur | (a) θ = 0.3571 | | (b) θ = 0.4286 | |
|---|---|---|---|---|
| (nm) | Patt. (1) | Patt. (2) | Patt. (1) | Patt. (2) |
| 50 | 82.0 nm | 78.0 nm | 91.2 nm | 89.4 nm |
| 70 | 76.7 nm | 69.5 nm | 88.4 nm | 85.4 nm |

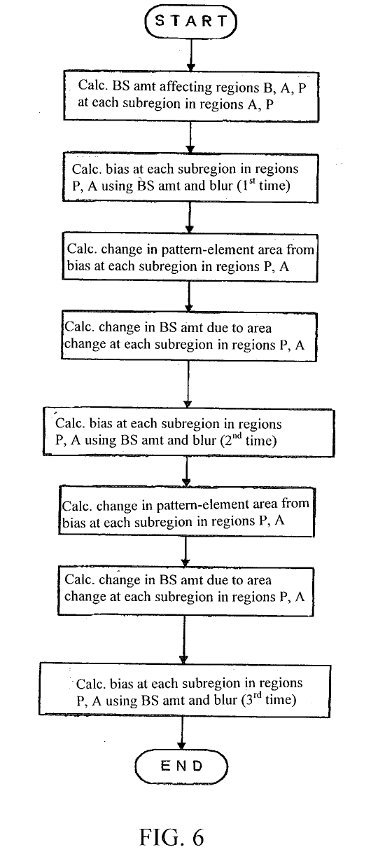

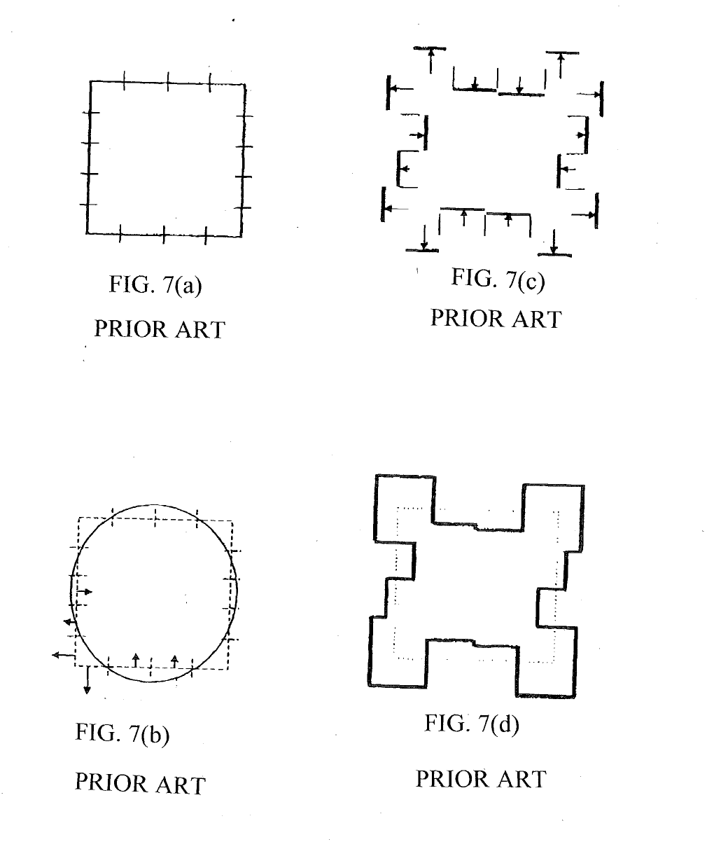

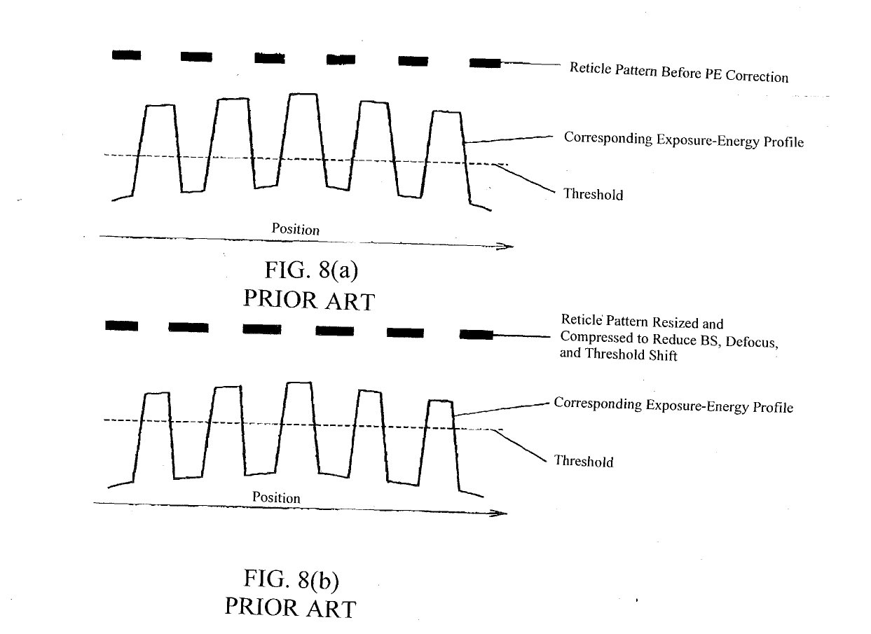

A process flowchart for this embodiment and for the examples is shown in FIG. 6, in which calculations of backscatter energy, magnitude of bias, and increase or decrease in area of pattern element(s) are repeated twice (i.e., a two-cycle or two-iteration calculation). When determining magnitude of bias, the inverse of the error function obtained using a Gaussian integral equivalent to blur is centered on a zero point and used as an equation developed to the third degree.

The Gaussian σ equivalent to blur is about 0.60× blur. That is,

σ=0.6(blur)

On the other hand, the Gaussian g(x) is:

$$g ( x ) = \frac{1}{{( π {σ}^{2} )}^{\frac{1}{2}}} exp ( - \frac{{x}^{2}}{{σ}^{2}} ) \qquad ( 6 )$$

Therefore, the result of a convolution with a step function in which x≧0=1 and x<0=0 is:

G(x)=(1+Erf[x/σ])/2 (7)

Using Equation (7), and taking into account contributions to forward-scattering, F(x) for cumulative exposure energy at a position x is:

F(x)=(1+Erf[x/σ])/2(1+η) (8)

If cumulative exposure energy from a position at which x=0 is changed by ΔU, if we assume that x (i.e., the position of an edge of the pattern element) experiences a bias, the magnitude of the bias is denoted Δx:

$$\begin{matrix}Δ U = F ( Δ x ) - F ( 0 ) \\ = [ 1 + Erf ( \frac{Δ x}{σ} ) ] / [ 2 ( 1 + η ) - \frac{1 + η}{2} ] \\ = Erf ( \frac{Δ x}{σ} ) / 2 ( 1 + η )\end{matrix} \qquad ( 9 )$$

If dU=2(1+η)ΔU, then Equation (9) becomes:

dU=Erf[Δx/σ] (10)

and Δx is expressed by:

$$\begin{matrix}Δ x = σ {Erf}^{- 1} ( dU ) \\ = σ [ \frac{1}{2} {π}^{\frac{1}{2}} ( dU ) + \frac{1}{24} {{π}^{\frac{3}{2}} ( dU )}^{3} + \frac{7}{960} {{π}^{\frac{5}{2}} ( dU )}^{5} + … ]\end{matrix} \qquad ( 11 )$$

If dU is taken to a third-order term, then the following bias is obtained:

$$Δ x = σ [ \frac{1}{2} {π}^{\frac{1}{2}} ( dU ) + \frac{1}{24} {{π}^{\frac{3}{2}} ( dU )}^{3} ] \qquad ( 12 )$$

Hence, if U₀ is the predicted cumulative energy obtained in the initial pattern design or the cumulative energy obtained in a previous stage of an iterative calculation, and if U is the cumulative energy obtained in the current stage of calculation, then ΔU=(U−U₀). dU is determined from ΔU, and the magnitude of bias Δx is calculated from dU using Equation (12).

Table 2 sets forth obtained post-bias line widths (nm) of the linear pattern elements of the pattern types (1) and (2):

TABLE 2

| Blur | (a) θ = 0.3571 | | (b) θ = 0.4286 | |
|---|---|---|---|---|
| (nm) | Patt. (1) | Patt. (2) | Patt. (1) | Patt. (2) |

Example 1: q = 5 μm, N = 6, M = 6:

| | | | | |
|---|---|---|---|---|
| 50 | 81.7 nm | 78.1 nm | 91.0 nm | 89.5 nm |
| 70 | 76.4 nm | 69.3 nm | 88.3 nm | 85.2 nm |

Example 2: q = 10 μm, N = 3, M = 3:

| | | | | |
|---|---|---|---|---|
| 50 | 81.9 nm | 78.0 nm | 91.1 nm | 89.4 nm |
| 70 | 76.9 nm | 69.2 nm | 88.5 nm | 85.1 nm |

The time required for calculating the bias for one subregion of a region was 17 msec for pattern-type (1) and 1.5 msec for pattern-type (2) (using a SPARC® 450 MHz, 1 CPU computer). The time required to process a 10 mm×10 mm chip is:

Example 1: (10/0.005)(10/0.005)(17 msec)=18.9 hours

Example 2: (10/0.01)(10/0.01)(1.5 msec)=0.42 hours

Comparing these results with the comparison example, it can be seen that the calculation time for a relatively complicated pattern such as shown in FIG. 5(a) is substantially shorter than the calculation time (35.56 hours) associated with the conventional model-based method applied to such a pattern. With the relatively simple pattern shown in FIG. 5(b), the calculation time using the conventional model-based method is only 1.78 hours, which is faster than Example 1. This indicates the possibility of changing subregion size to reduce calculation time in Example 1. (Excessively small subregion sizes cause long calculation times.) Most actual patterns are similar to FIG. 5(a) in complexity, which (as shown above) can be calculated substantially faster using the current method than conventionally. It also is pointed out that, in either example, calculation time for determining bias using the current method does not depend upon pattern-element shapes. Rather, for a given subregion size, calculation time is the same for both pattern types (1) and (2) in FIGS. 5(a) and 5(b), respectively. In the examples 1 and 2, 17 msec is the calculation time for example 1, and 1.5 msec is the calculation time for example 2. The difference between examples 1 and 2 is in subregion size. So, the number of subregions contributing backscatter energy to the subject subregion is different in each example, which is the main reason for the difference in calculation time between the two examples.

If calculations for the various subregions were divided and processed using multiple parallel processors, then the calculation speed can be further increased and calculation time correspondingly reduced. Pattern-type (2) required a long time compared to one-dimensional model-based calculations. But, the reason for the long time was that pattern-type (2) was a very simple pattern with which model-based calculations are relatively simple and can be performed quickly. Pattern-type (1) was more similar to an actual pattern, with which calculations according to the instant method can be performed in less time than a model-based calculation.

With respect to error, the line-width realized with the comparison example was compared with line-widths obtained in the examples. Even in the most extreme instance the difference was less than 0.4 nm. This shows that adequate precision can be achieved.

In the foregoing example the final magnitude of bias was found by iteratively calculating the backscattering energy, bias, and pattern-element area. Alternatively, it is possible to find the final bias by solving a simultaneous equation instead of an iterative calculation.

For example, and to simplify matters, let the subject of correction be a pattern extending only in a first subregion and a second subregion. If the slopes of the energy profile in the respective regions are α₁ and α₂, respectively, then the initial biases Δx₁ and Δx₂ are:

Δx₁=−(U₁+ΔU₁−U₀)/α₁

Δx₂=−(U₂+ΔU₂−U₀)/α₂

Here, U₁ and U₂ denote the cumulative exposure energy in each subregion according to the initially configured pattern elements, ΔU₁ and ΔU₂ are the energy changes in each subregion as the result of applying the biases Δx₁ and Δx₂, respectively, and U₀ is the exposure threshold of the resist.

Generally, if the increase or decrease in area of pattern element(s) in a subregion i and the backscatter energy affecting a subregion j are expressed as Cᵢⱼ, then:

ΔU₁=C₁₁ΔS₁+C₁₂ΔS₂

ΔU₂=C₂₁ΔS₁+C₂₂ΔS₂

Removing the second term of Equation (5) and substituting therein yields:

ΔS₁=p₁Δx₁

ΔS₂=p₂Δx₂

wherein p₁ and p₂ are the peripheral length of the first and second subregions, respectively. Thus, the simultaneous equation is produced:

(C₁₁p₁+α₁)Δx₁+C₁₂p₂Δx₂=U₀−U₁

C₂₁p₁Δx₁+(C₂₂p₂+α₂)Δx₂=U₀−U₂

and an appropriate bias is found by solving this equation for Δx₁ and Δx₂.

Even if the number of subregions constituting a system to be corrected is larger than two, the respective biases can be found in the same manner by creating a simultaneous equation.

If the size of a subregion is sufficiently small relative to the backscattering radius, the distance between the centers of two subregions can be approximated as “r” in the expression:

$${C}_{ij} = ( \frac{η}{1 + η} ) ( \frac{1}{π {σ}_{b}^{2}} ) exp [ - \frac{{r}^{2}}{{σ}_{b}^{2}} ] \qquad ( 13 )$$

Whereas the invention has been described in connection with representative embodiments and examples, the invention is not limited to those embodiments and examples. On the contrary, the invention is intended to encompass all modifications, alternatives, and equivalents as may be included within the spirit and scope of the invention, as defined by the appended claims.

What is claimed is:

1. In a pattern to be microlithographically transferred from a reticle to a substrate using a charged particle beam, a method for determining respective configurations of elements of the pattern as defined on the reticle so as to reduce proximity effects on the pattern elements as the pattern elements are transferred to the substrate, the method comprising:
dividing the pattern, as defined on the reticle, into multiple subregions each containing one or more respective pattern elements;
for each subregion, determining a respective bias to be applied to the one or more respective pattern elements in the subregion to reduce a proximity effect that otherwise would be manifest when the subregion is transferred to the substrate; and
applying the determined respective bias to the respective one or more pattern elements in each subregion, so as to reconfigure the respective pattern elements, as defined on the reticle, in each subregion in which bias is applied.

2. The method of claim 1, further comprising the step, for each subregion, of determining a backscatter-energy contribution that would have a significant effect on total backscatter energy in the subregion, if the bias were not applied, when the subregion is projected onto the substrate.

3. The method of claim 2, wherein the step of determining the bias comprises calculating the bias for a respective subregion by taking into account the backscatter, occurring inside and outside the respective subregion, that would have the significant effect on total backscatter energy in the respective subregion.

4. The method of claim 3, wherein the step of taking into account the backscatter occurring inside and outside the respective subregion comprises calculating a change in backscatter energy in the respective subregion achieved by biasing pattern elements inside and outside the respective subregion.

5. The method of claim 4, wherein the step of calculating the change in backscatter energy comprises calculating respective changes in backscatter energy corresponding to changes in bias applied to pattern elements inside and outside the respective subregion.

6. The method of claim 5, wherein:
the step of calculating backscatter energy corresponding to changes in bias comprises calculating respective changes in area of the pattern elements inside and outside the respective subregion; and
for each such pattern element, the change in area is calculated from a total perimeter length, a total number of projecting vertices, and a total number of indented vertices of the pattern element.

7. The method of claim 2, wherein the step of determining the backscatter-energy contribution comprises determining a change in backscatter energy caused by a change in bias of pattern elements inside and outside the respective subregion.

8. The method of claim 7, further comprising the step of calculating the change in bias of the pattern elements.

9. The method of claim 8, wherein the change in bias of the pattern elements is calculated, for each respective pattern element, by calculating a respective change in area of the respective pattern elements.

10. The method of claim 9, wherein the change in area is calculated from a total perimeter length, a total number of projecting vertices, and a total number of indented vertices of the respective pattern element.

11. The method of claim 1, wherein the step of determining the bias further comprises taking into account a respective blur of the charged particle beam used to transfer the respective subregion from the reticle to the substrate.

12. The method of claim 11, further comprising calculating the respective blur.

13. The method of claim 2, wherein the step of determining the respective backscatter-energy contribution in a subject subregion comprises performing an iterative calculation of a change in backscatter energy significantly affecting the subject subregion caused by respective changes in pattern-element area, resulting from application of respective biases, in a group of subregions including the subject subregion and subregions neighboring the subject subregion, wherein each of the neighboring subregions included in the calculation exhibits a backscatter that significantly affects the backscatter energy in the subject subregion.

14. The method of claim 13, wherein the step of performing the iterative calculation comprises the steps:
(a) calculating a backscatter-energy contribution, to the subject subregion, from subregions located within a predetermined distance from the subject subregion and that exhibit respective backscatter amounts having a significant effect on total backscatter energy in the subject subregion;
(b) calculating, from the backscatter-energy contributions calculated in step (a) and from beam blur, a corresponding bias at each of the subregions;
(c) calculating, from the biases calculated in step (b), corresponding changes in pattern-element area in each of the subregions;
(d) calculating, from the changes in pattern-element area determined in step (c), corresponding changes in backscatter energy in each of the subregions; and
(e) repeating steps (b)-(d) at least once.

15. The method of claim 13, wherein the step of determining the respective backscatter-energy contribution in the subject subregion further comprises:
of the neighboring subregions, determining a set of subregions exhibiting respective backscatter amounts that have a significant effect on total backscatter energy in the subject subregion;
within the set of neighboring subregions, determining a distance range from the subject subregion that divides the neighboring subregions into a first group of subregions that are relatively close to the subject subregion and a second group of subregions that are relatively distant from the subject subregion; and
the step of determining the total backscatter energy in the subject subregion includes taking into account respective contributions of changed backscatter energy from neighboring subregions within the distance range and ignoring respective contributions of changed backscatter energy from neighboring subregions at or beyond the distance range.

16. The method of claim 2, wherein the step of determining the respective backscatter energy in a subject subregion comprises:
establishing a set of simultaneous equations for the subject subregion, the equations in the set pertaining to respective contributions by neighboring subregions of respective backscatter energies having a significant effect on the proximity effect in the subject region and in which equations an unknown is the respective bias in the respective subregion; and
solving the set of simultaneous equations to determine the bias to be applied in the subject subregion.

17. The method of claim 16, wherein the step of determining the respective backscatter energy in the subject subregion comprises performing an iterative calculation of a change in backscatter energy affecting the subject subregion caused by respective changes in pattern-element area, resulting from application of respective biases in the neighboring subregions, wherein each of the neighboring subregions included in the iterative calculation exhibits a respective backscatter amount that significantly affects the total backscatter energy in the subject subregion.

18. The method of claim 17, wherein the step of performing the iterative calculation comprises the steps:
(a) calculating a backscatter-energy contribution, to the subject subregion, from subregions located within a predetermined distance from the subject subregion and that exhibit respective backscatter amounts having a significant effect on total backscatter energy in the subject subregion;
(b) calculating, from the backscattering contributions calculated in step (a) and from beam blur, a corresponding bias at each of the subregions;
(c) calculating, from the biases calculated in step (b), corresponding changes in pattern-element area in each of the subregions;
(d) calculating, from the changes in pattern-element area determined in step (c), corresponding changes in respective backscatter energy in each of the subregions; and
(e) repeating steps (b)-(d) at least once.

19. A computer-readable medium inscribed with a computer program encoding the method of claim 1.
